(19) United States
(12) Patent Application Publication
(10) Pub. No.: US 2014/0232249 A1
(43) Pub. Date: Aug. 21, 2014

(54) PROTECTION DEVICE FOR HVAC UNITS

(71) Applicant: Nathan White, Oklahoma City, OK (US)

(72) Inventor: Nathan White, Oklahoma City, OK (US)

(21) Appl. No.: 13/768,467

(22) Filed: Feb. 15, 2013

(51) Int. Cl. E05B 65/00; A47B 91/00; A47B 46/00

(52) U.S. Cl. CPC E05B 65/0089; A47B 46/00; A47B 91/005
USPC 312/215; 312/351.1; 312/326; 312/351.3

(57) ABSTRACT

This disclosure is related to protective devices that can protect and secure various structures. The structures can be disposed on a horizontally disposed surface or a vertically disposed surface. The protection devices can comprise protective cage and protective gate members. The protection devices can also include securing members to prevent the protective cage and gate members from being opened.

### CROSS-REFERENCE TO RELATED APPLICATIONS

The present application is a conversion of U.S. Provisional Application having U.S. Ser. No. 61/599,278, filed Feb. 15, 2012, which claims the benefit under 35 U.S.C. 119(e). The disclosure of which is hereby expressly incorporated herein by reference.

### STATEMENT REGARDING FEDERALLY SPONSORED RESEARCH OR DEVELOPMENT

Not applicable.

### BACKGROUND OF THE INVENTION

1. Field of the Invention

The present invention relates to a protection device for encapsulating heating, ventilation and air conditioning (HVAC) units to prevent the vandalism and theft of HVAC components. The present invention is designed to protect traditional HVAC units disposed on the ground and HVAC units disposed on vertical walls.

2. Description of the Related Art

HVAC units include components made of valuable materials, such as copper, and destruction of the HVAC units to steal these valuable materials is a problem. Protecting these HVAC units, and still having access to the units for maintenance, is another consideration when protecting these HVAC units. Accordingly, there is a need for a protection device for HVAC units that protect the HVAC units from theft, but still permit access for maintenance.

### SUMMARY OF THE INVENTION

The present disclosure is directed to a device for protecting various structures mounted to a horizontally disposed surface. The device includes a base portion supported by the horizontally disposed surface. The device further comprises at least one protective cage member supported by the base portion. Finally, the device includes a first and second securing member for allowing the at least one protective cage member to be secured to the base portion.

The present disclosure is related to a device for protecting a structure mounted to a vertically disposed surface. The device includes a plurality of protective gate members attached to the vertically disposed surface. The device also includes a first and second securing member attached to the plurality of protective gate members for securing the plurality of protective gate members to each other.

### BRIEF DESCRIPTION OF THE DRAWINGS

FIG. 1 is a perspective view of a protection device constructed in accordance with the present disclosure.

FIG. 2 is another perspective view of the protective device constructed in accordance with the present disclosure.

FIG. 3 is a perspective view of a security element constructed in accordance with the present disclosure.

FIG. 4 is a perspective view of another embodiment of the protective device constructed in accordance with the present disclosure.

FIG. 5 is another perspective view of the protective device constructed in accordance with the present disclosure.

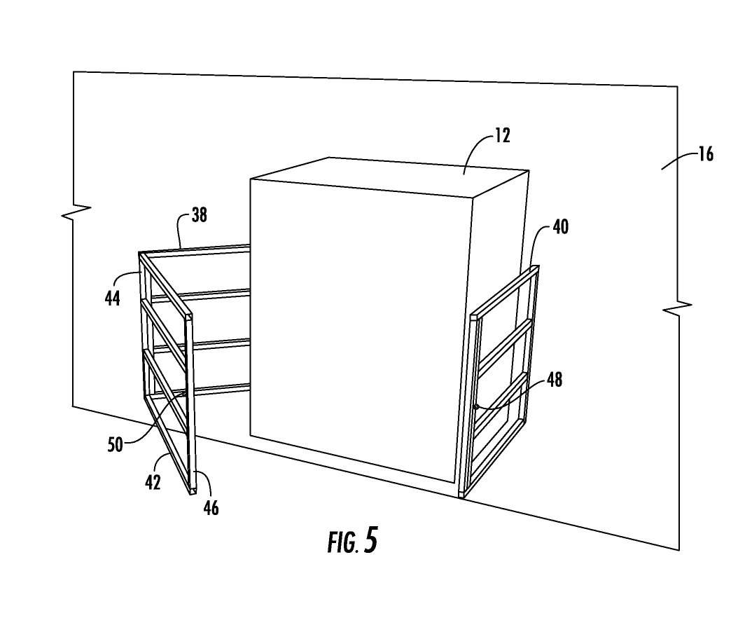

FIG. 6 is a perspective view of a lock security box constructed in accordance with the present disclosure.

FIG. 7 is another perspective view of the lock security box constructed in accordance with the present disclosure.

FIG. 8 is another perspective view of the lock security box constructed in accordance with the present disclosure.

FIG. 9 is another perspective view of the lock security box constructed in accordance with the present disclosure.

FIG. 10 is a perspective view of a lock box constructed in accordance with the present disclosure.

FIG. 11 is another perspective view of the lock box constructed in accordance with the present disclosure.

FIG. 12 is another perspective view of the lock box constructed in accordance with the present disclosure.

FIG. 13 is another perspective view of the lock box constructed in accordance with the present disclosure.

### DETAILED DESCRIPTION OF THE INVENTION

The present invention relates to a protection device 10 for encapsulating any desired structure 12, such as an HVAC unit, to protect the structure 12 and also permit access to the protected structure 12 to only those with authority or permission to access the protected structure 12. Typically, structures 12 for which protection is desirable are mounted on a horizontally disposed surface 14, such as the ground, a rooftop, or a cement pad on the ground, or a vertically disposed surface 16, such as a wall.

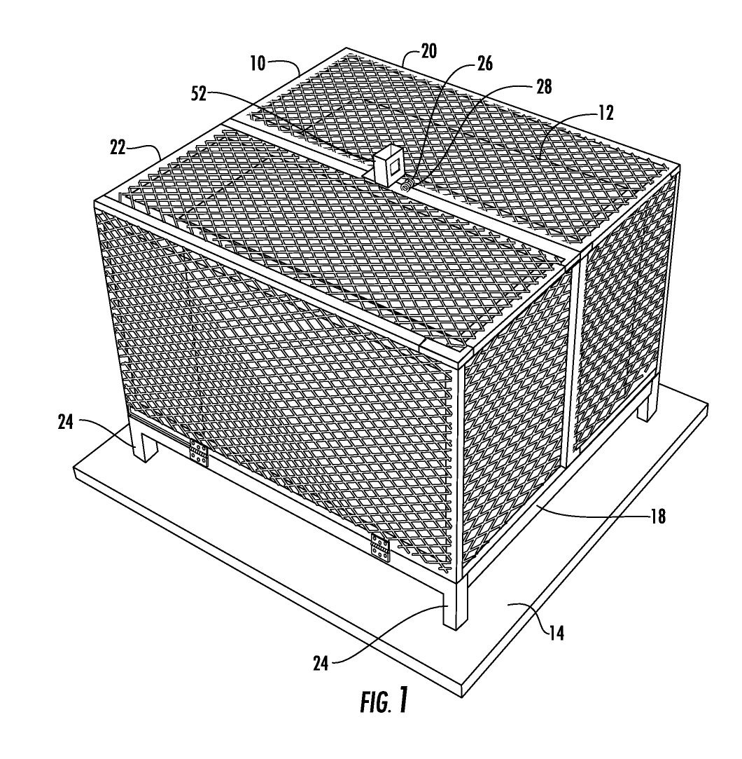

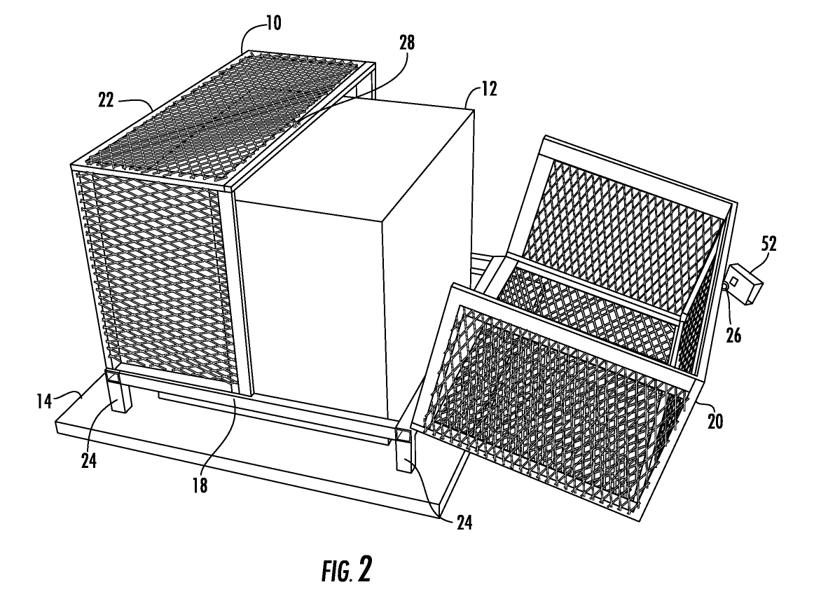

In one embodiment, shown in FIGS. 1 and 2, the protection device 10 includes a base portion 18 attached to, or supported by, the horizontally disposed surface 14, a first protective cage member 20 pivotably attached to the base portion 18 and a second cage member 22 pivotably attached to the base portion 18. The first and second protective cage members 20 and 22 are designed such that the first and second protective cage members 20 and 22 can be opened and closed. When the first and second protective cage members 20 and 22 are in the closed position, the first and second protective cage members 20 and 22 are securable to each other to prevent access to the structure 12 being protected. The cage members 20 and 22 can be constructed of any material and designed in any such manner that access to the structure 12 or vital portions of the structure 12 is severely limited. For example, the cage members 20 and 22 can be constructed of heavy duty bars, rods, mesh, a combination thereof, and the like. In another embodiment, the protection device can include only a single protective cage member 20 or 22 secured to the base portion 18.

In another embodiment, the first protective cage member 20 includes a first securing member 26 attached thereto and the second cage member 22 includes a second securing member 28 attached thereto. The first and second securing members 26 and 28 can be secured to each other to ultimately secure the first and second protective cage members 20 and 22 in the closed position. In another embodiment, the securing members 26 and 28 can be attached to one of the protective cage members 20 or 22 and the base portion 18. In one embodiment, the first and second securing members 26 and 28 are ring-shaped such that a securing device, such as a padlock, can be used to secure them together. It should be understood that the first and second securing members 26 and 28 can be any shape such that they permit some sort of locking device to be used to secure them together. Also, the securing device can be any type of lock known by those of ordinary skill in the art. Examples include, but are not limited to, padlocks, combination locks, etc.

In another embodiment, the base portion 18 of the protection device 10 includes a plurality of support legs 24 for positioning the protection device 10 off the ground. The support legs 24 can be secured to the horizontally disposed surface 14 to prevent the protection device 10 from being easily bypassed and/or removed. The horizontally disposed surface 14 can be the ground, a roof top, a concrete pad or any surface that is capable of supporting a protected structure 12.

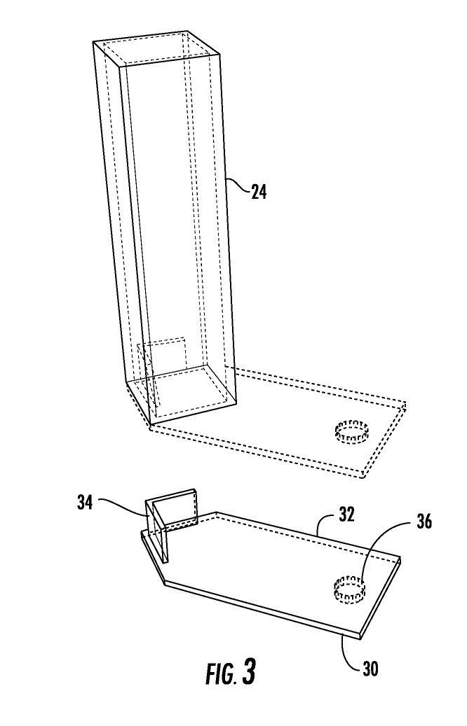

In a further embodiment, shown in FIG. 3, the protection device 10 can include a plurality of security elements 30 for strengthening the attachment of the protection device 10 to the horizontally disposed surface 14. The security elements 30 include a horizontal support portion 32 that is attachable to the horizontally disposed surface 14, a vertical support portion 34 that is attached to the horizontal support portion 32 and attachable to one of the support legs 24, and an opening 36 in the horizontal support portion 32 for attachment to the horizontally disposed surface 14. The vertical support portion 34 can be attached to one end of the horizontal support portion 32 and the opening 36 disposed in the other end of the horizontal support portion 32 so that the opening 36 extends under the protected structure 12. This allows the opening 36 (and thus the mechanical attachment of the security element 30) of the horizontal support portion 32 to be attached to the horizontally disposed surface 14 under the protected structure where accessibility is severely limited. The vertical support portion 34 of the security element 30 can be attached to the support leg 24. In one embodiment, the vertical support portion 34 is secured to an internal portion of the support leg 24. The vertical support portion 34 provides more surface area to increase the security and stability of the support legs 24 to prevent the protection device 10 from being removed from the protected structure 12.

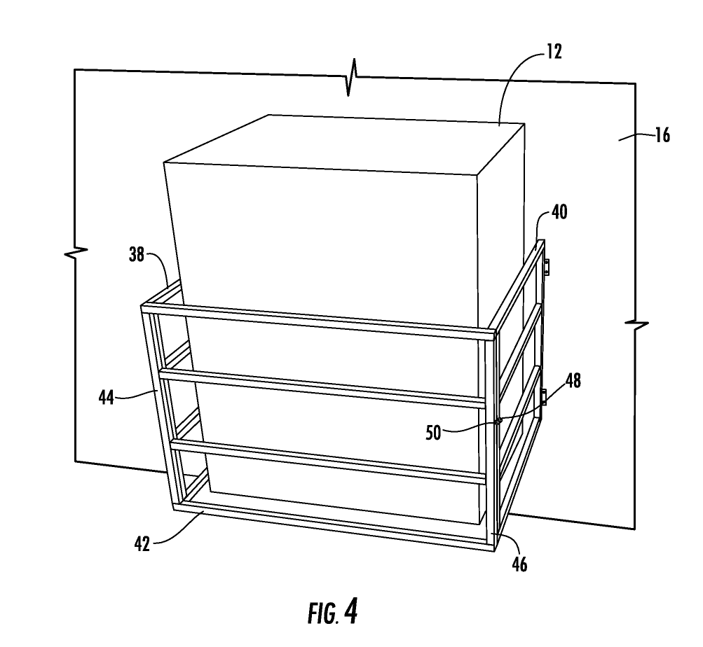

FIG. 4 shows another embodiment of the present disclosure. In this embodiment, the protected structure 12 is mounted to the vertically disposed surface 16. The protection device 10 in this embodiment includes a first protective gate member 38 attached (can be pivotably attached) to the vertically disposed surface 16, a second protective gate member 40 attached (can also be pivotably attached) to the vertically disposed surface 16, and a third protective gate member 42 supported by the first and second protective gate members 38 and 40. In one embodiment, the third protective gate member 42 has a first end 44 and a second end 46. The first end 44 of the third protective gate member 42 is pivotably attached to the first protective gate member 38 (or the second protective gate member 40) to allow the protective device 10 to be open and closed to permit access to the protected structure 12. The second end 46 of the third protective gate member 42 can be secured to the second protective gate member 40 (or the first protective gate member 38) to maintain the protection device 10 in a closed position. Similar to the first and second protective cage members 20 and 22, the first, second and third protective gate members 38, 40 and 42 can be constructed of any material and designed in any such manner that access to the structure 12 or vital portions of the structure 12 is severely limited. For example, the first, second and third protective gate members 38, 40 and 42 can be constructed of heavy duty bars, rods, mesh, a combination thereof, and the like.

In another embodiment, the second end 46 of the third protective gate member 42 includes a first securing member 48 attached thereto and the second protective gate member 40 (or the first protective gate member 38) includes a second securing member 50 attached thereto. The first and second securing members 48 and 50 can be secured to each other to ultimately secure the first, second and third protective gate members 38, 40 and 42 in the closed position. In one embodiment, and similar to what is described herein for the first and second securing members 26 and 28, the first and second securing members 48 and 50 of the gate members 38, 40 and 42 are ring-shaped such that a securing device, such as a padlock, can be used to secure them together. It should be understood that the first and second securing members 48 and 50 can be any shape such that they permit some sort of locking device to be used to secure them together.

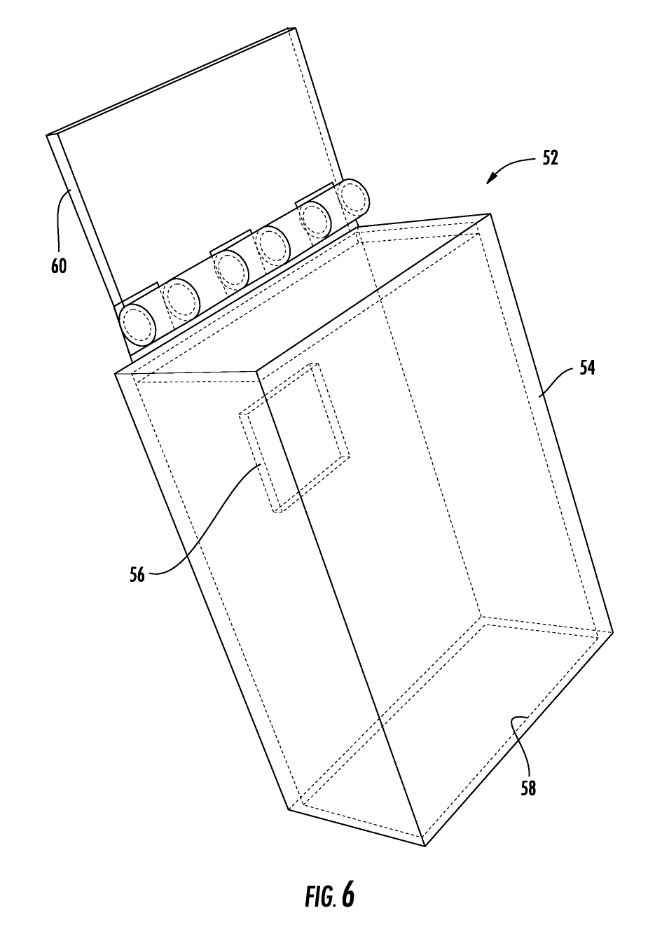

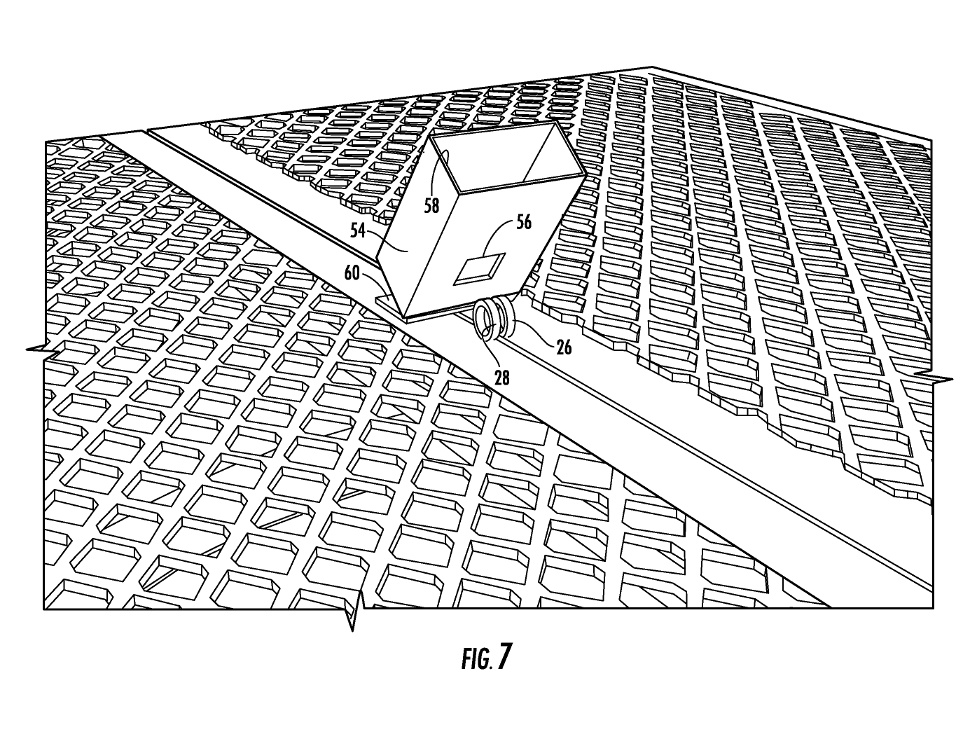

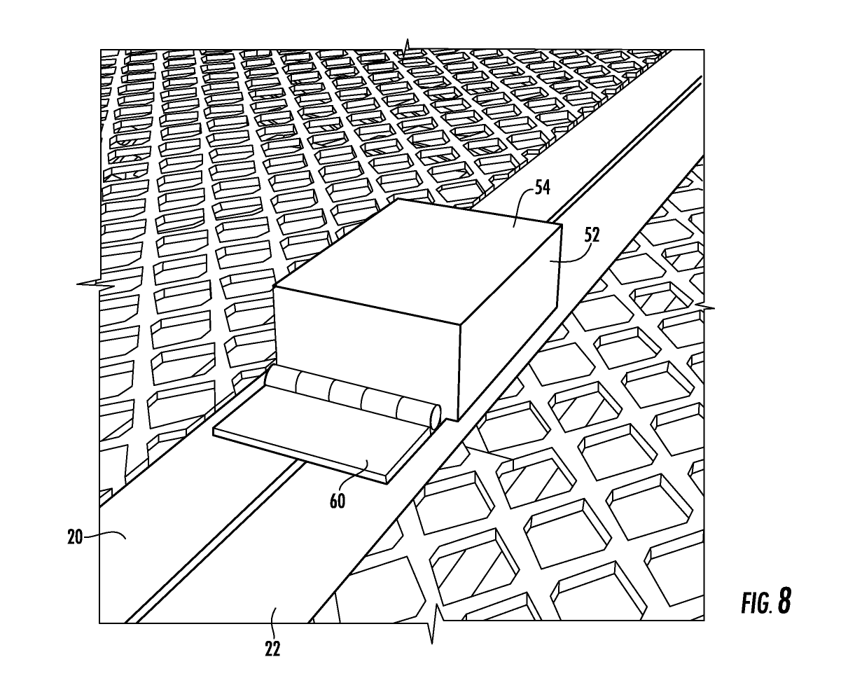

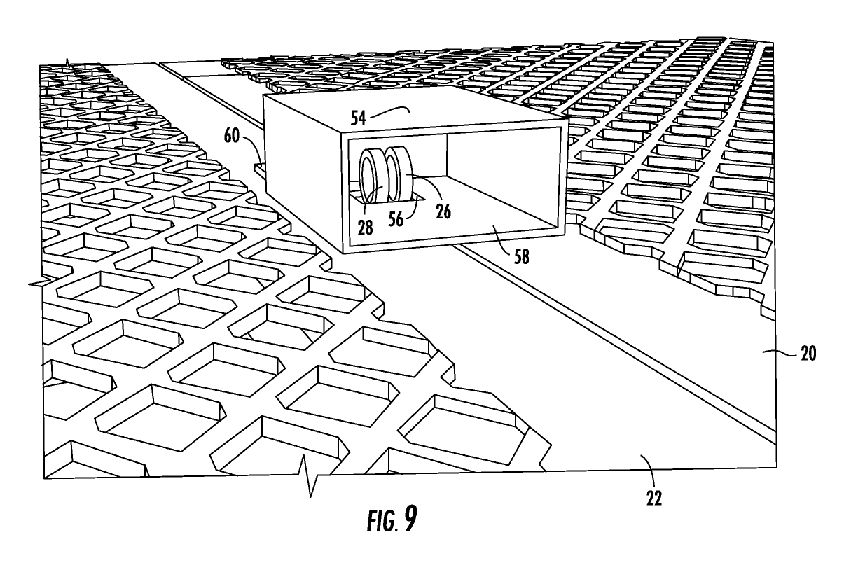

In yet another embodiment of the present disclosure, and shown in FIGS. 6-9, the protective device 10 can include a lock security box 52 to prevent the securing devices used to secure the first and second securing members 26, 28, 48 and 50 from being compromised. The lock security box 52 includes a box-like structure 54 with a first opening 56 for receiving the first and second securing members 26 and 28 or the first and second securing members 48 and 50, and a second opening 58 for receiving the securing device and permitting the securing device access to the first and second securing members 26 and 28 or the first and second securing members 48 and 50.

In another embodiment, the lock security box 52 is pivotably connected to an attachment member 60 for securing the lock security box 52 to either the first or second protective cage member 20 or 22, or the first, second, or third protective gate members 38, 40 or 42. When the securing device is removed from the first and second securing members 26 and 28 or the first and second securing members 48 and 50, and removed from inside the box-like structure 54, the box-like structure 54 can be pivoted which permits the first and second protective cage members 20 and 22 or first, second and third protective gate members 38, 40 and 42 to be separated to expose the protected structure 12. The lock security box 52 can be constructed of any material known in the art sufficient in strength to protect the securing devices from being compromised by someone who is not entitled to access to the protected structure 12.

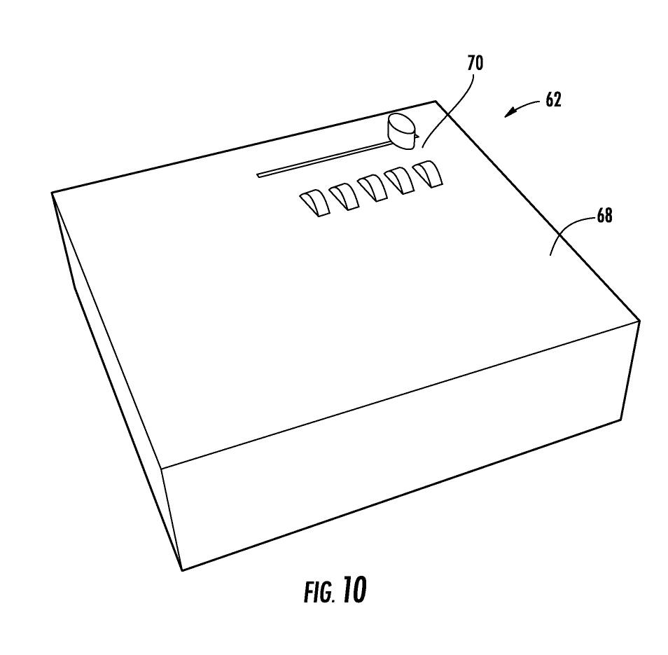

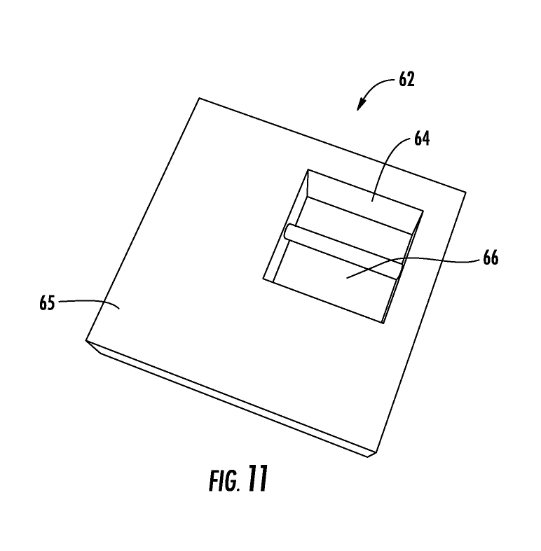

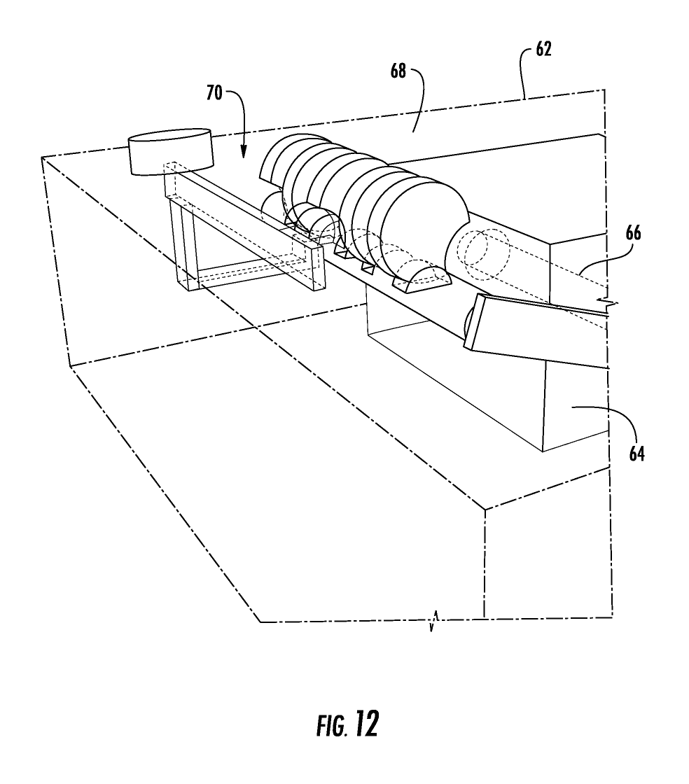

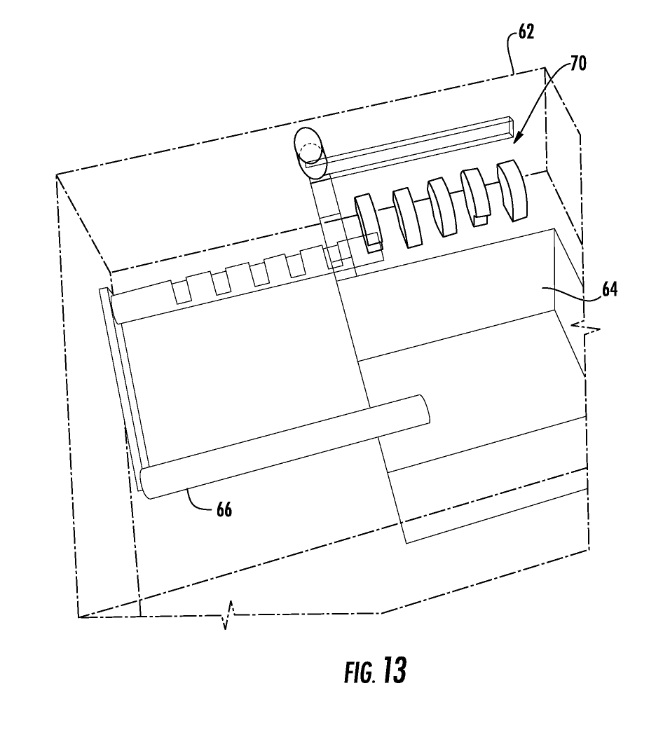

In yet another embodiment of the present disclosure, shown in FIGS. 10-13, the protection device 10 can include a lock box 62 for securing the first and second securing members 26 and 28 together or the first and second securing members 48 and 50 together. The lock box 62 includes a depression area 64 for receiving the first and second securing members 26 and 28 or the first and second securing members 48 and 50. In one embodiment, the depression area 64 is on a backside 65 of the lock box 62.

The lock box 62 also includes a locking element 66 that telescopically extends through the depression area 64 to engage the first and second securing members 26 and 28 or the first and second securing members 48 and 50. The locking element 66 can be a rod or bar or any other structure known in the art for extending through the first and second securing members 26 and 28 or the first and second securing members 48 and 50 to secure them together and prevent the first and second protective cage members 20 and 22 and/or the first, second and third protective gate members 38, 40 and 42 from being opened and allowing access to the protected structure 12. The locking element 66 is hidden behind a front face 68 of the lock box 62 and its only exposure is when it extends through the depression area 64.

The lock box 62 also includes a locking means 70 attached to the locking element 66 to permit the selective telescoping of the locking element 66 through the depression area 64. Examples of locking means 70 include, but are not limited to, a key accessible lock, a combination lock, a magnetically-actuated locking device, and the like. It should be understood and appreciated that FIGS. 10, 11 and 13 show a combination lock, but this is only by way of example. Although not shown in the FIGS, it should be understood and appreciated that the lock box 62 can include an attachment member 60 and be attached to portions of the protection device 10 similar to the lock security box 52.

All connections described herein as pivotably connected are typically accomplished with hinges. The hinges used for this disclosure can be any type of hinge known in the art. In one embodiment, the hinges are a durable hinge that prevents people without proper access from accessing the protected structure 12. In a further embodiment, the hinges are a highly durable permanent pin hinge.

From the above description, it is clear that the present invention is well adapted to carry out the objectives and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed.

What is claimed is:

1. A device for protecting various structures mounted to a horizontally disposed surface, the device comprising:
a base portion supported by the horizontally disposed surface;
at least one protective cage member supported by the base portion; and
a first and second securing member for allowing the at least one protective cage member to be secured to the base portion.

2. The device of claim 1 further comprising a first and second protective cage member pivotably attached to the base portion.

3. The device of claim 2 wherein the first securing member is attached to the first protective cage member and the second securing member is attached to the second protective cage member, the first and second securing members securable together with a securing device.

4. The device of claim 2 further comprising a plurality of support legs attached to the base portion, the support legs securable to the horizontally disposed surface.

5. The device of claim 1 whe rein the structure being protected is a heating unit, ventilation unit, air conditioning unit, or a combination thereof.

6. The device of claim 4 further comprising security elements attached to the support legs, the security elements having a horizontal support portion that is attachable to the horizontally disposed surface and a vertical portion attached to the horizontal support portion that is attachable to the support legs.

7. The device of claim 3 further comprising a lock security box, the lock security box comprising a box-like structure with a first opening for receiving the first and second securing members and a second opening for receiving the securing device to access the first and second securing members and secure them together.

8. The device of claim 7 wherein the lock security box is pivotably attached to the first or second protective cage members.

9. The device of claim 3 further including a lock box includes a backside with a depression area disposed therein for receiving the first and second securing members, a locking element that telescopically extends through the depression area to be able to extend through the first and second securing members, and a locking means attached to the locking element for permitting the selective telescoping of the locking element.

10. The device of claim 9 wherein the lock box is pivotably attached to the first or second protective cage members.

11. A device for protecting a structure mounted to a vertically disposed surface, comprising:
a plurality of protective gate members attached to the vertically disposed surface; and
a first and second securing member attached to the plurality of protective gate members for securing the plurality of protective gate members to each other.

12. The device of claim 11 further comprising a first, second, and third protective gate member, the first and second protective gate members are pivotably attached to the vertically disposed surface, the third protective gate member pivotally attached to the first or second protective gate member and is securable to the first or second protective gate member.

13. The device of claim 12 wherein the first securing member is attached to the first or second protective gate member and the second securing member is attached to the third protective gate member, the first and second securing members securable together with a securing device.

14. The device of claim 11 wherein the structure being protected is a heating unit, ventilation unit, air conditioning unit, or a combination thereof.

15. The device of claim 13 further comprising a lock security box, the lock security box comprising a box-like structure with a first opening for receiving the first and second securing members and a second opening for receiving the securing device to access the first and second securing members and secure them together.

16. The device of claim 15 wherein the lock security box is pivotably attached to the first, second or third protective gate members.

17. The device of claim 13 further including a lock box includes a backside with a depression area disposed therein for receiving the first and second securing members, a locking element that telescopically extends through the depression area to be able to extend through the first and second securing members, and a locking means attached to the locking element for permitting the selective telescoping of the locking element.

18. The device of claim 17 wherein the lock box is pivotably attached to the first, second, or third protective gate members.
